(19) United States
(12) Patent Application Publication
(10) Pub. No.: US 2026/0239497 A1
(43) Pub. Date: Aug. 13, 2026

(54) Microwave Oven

(71) Applicants: Guangdong Midea Kitchen Appliances Manufacturing Co., Ltd., Foshan (CN); Midea Group Co., Ltd., Foshan (CN)

(72) Inventors: Qihong LING, Foshan (CN); Jae Man CHO, Foshan (CN); Gang LIU, Foshan (CN); Lin AN, Foshan (CN); Niting SHI, Foshan (CN); Wei LI, Foshan (CN)

(21) Appl. No.: 19/155,220

(22) PCT Filed: Aug. 23, 2023
(86) PCT No.: PCT/CN2023/114505

§ 371 Date: Aug. 8, 2025

(30) Foreign Application Priority Data
Feb. 9, 2023 (CN) 202310107608.3
Feb. 9, 2023 (CN) 202310107624.2

(51) Int. Cl. H05B 6/64; H05B 6/70

(52) U.S. Cl. CPC H05B 6/642; H05B 6/707; H05B 2206/044

(57) ABSTRACT

Provided is a microwave oven. The microwave oven includes: a housing (1), a fan (2), a frequency converter (3), and a magnetron (4). The housing (1) has a cooking cavity inside the housing. The housing further has a mounting cavity (12) formed on the housing. The mounting cavity (12) includes a first mounting cavity (121) located at a rear side of the cooking cavity. The fan (2) is disposed in the first mounting cavity (121). The frequency converter (3) is disposed in the first mounting cavity (121). The magnetron (4) is disposed in the first mounting cavity (121). In a left-right direction of the housing (1), the fan (2) and the magnetron (4) are located at two sides of the frequency converter (3), respectively.

### CROSS-REFERENCE TO RELATED APPLICATIONS

This application claims priorities to Chinese Patent Applications No. 202310107608.3 and No. 202310107624.2, both filed on Feb. 9, 2023, the entire contents of which are incorporated herein by reference.

### FIELD

The present disclosure relates to the technical field of household electrical appliances, and in particular, to a microwave oven.

### BACKGROUND

In the related art, a structural arrangement inside an electrical compartment of a microwave oven is unreasonable, which leads to scattered distribution of heat sources in the electrical compartment, resulting in a problem that a heat-generating electrical component cannot be effectively cooled, which reduces efficiency of a heat dissipation system.

### SUMMARY

The present disclosure aims to at least solve one of the technical problems existing in the related art. To this end, the present disclosure provides a microwave oven. A magnetron and a frequency converter of the microwave oven have good heat dissipation effects, and overall performance and a service life of the microwave oven are improved.

The microwave oven according to embodiments of the present disclosure includes a housing, a fan, a frequency converter, and a magnetron. The housing has a cooking cavity inside the housing. The housing further has a mounting cavity formed on the housing. The mounting cavity includes a first mounting cavity located at a rear side of the cooking cavity. The fan is disposed in the first mounting cavity. The frequency converter is disposed in the first mounting cavity. The magnetron is disposed in the first mounting cavity. In a left-right direction of the housing, the fan and the magnetron are located at two sides of the frequency converter, respectively.

With the microwave oven according to the embodiments of the present disclosure, the fan, the frequency converter, and the magnetron are disposed in the first mounting cavity, and the fan and the magnetron are respectively located at the two sides of the frequency converter in the left-right direction of the housing. Therefore, cooling air blown by the fan flows over the frequency converter to effectively dissipate heat from the frequency converter. After taking away the heat from the frequency converter, the cooling air is blown to the magnetron to dissipate heat from the magnetron. According to different amounts of heat generated by the magnetron and the frequency converter during operation and different requirements of the magnetron and the frequency converter for a surrounding temperature, the cooling air blown by the fan is allowed to provide an optimal heat dissipation effect for the magnetron and the frequency converter, improving the overall performance and the service life of the microwave oven.

In some embodiments of the present disclosure, a plurality of frequency converters and a plurality of magnetrons are provided. The plurality of magnetrons correspond to the plurality of frequency converters in a one-to-one correspondence.

In some embodiments of the present disclosure, the plurality of frequency converters are arranged in an up-down direction of the housing. The plurality of magnetrons are arranged in the up-down direction of the housing.

In some embodiments of the present disclosure, the plurality of frequency converters includes a first frequency converter and a second frequency converter. The plurality of magnetrons includes a first magnetron and a second magnetron. The first frequency converter is connected to the first magnetron. The second frequency converter is connected to the second magnetron.

In some embodiments of the present disclosure, the microwave oven further includes an air guide part disposed in the first mounting cavity and located between the fan and the magnetron. The air guide part has a heat dissipation air duct defined in the air guide part. The frequency converter is located in the heat dissipation air duct. The heat dissipation air duct has a heat dissipation inlet facing the fan and a heat dissipation outlet facing the magnetron, and the heat dissipation air duct is configured to guide air blown by the fan to the frequency converter and the magnetron.

In some embodiments of the present disclosure, the heat dissipation air duct has a first groove formed on a wall surface of the heat dissipation air duct close to the cooking cavity. The first groove extends in an arrangement direction of the fan and the frequency converter and is located at a side of the frequency converter, and the heat dissipation inlet and the heat dissipation outlet are in communication with the first groove.

In some embodiments of the present disclosure, the microwave oven further includes a fan casing disposed in the mounting cavity and connected to the air guide part. The fan casing has a fan cavity, and an air inlet and an air outlet that are in communication with the fan cavity. The fan is disposed in the fan cavity to drive an airflow to flow from the air inlet to the air outlet, and the heat dissipation inlet is in communication with the air outlet.

In some embodiments of the present disclosure, the air guide part further defines a cooking air duct in communication with the air outlet. The cooking air duct is in communication with the cooking cavity.

In some embodiments of the present disclosure, the cooking air duct includes a second groove formed at a side of the air guide part facing the cooking cavity. An end of the second groove is in communication with the air outlet, and an opening of the second groove is in communication with the cooking cavity.

In some embodiments of the present disclosure, the fan casing has a third groove formed at a side of the fan casing facing the cooking cavity. The third groove has an end in communication with the air outlet and another end in communication with the second groove, and an opening of the third groove is in communication with the cooking cavity.

In some embodiments of the present disclosure, two cooking air ducts are provided and are located at two sides of the frequency converter in a direction perpendicular to an arrangement direction of the fan and the frequency converter, respectively. Two heat dissipation inlets are provided and are located at the two sides of the frequency converter in the direction perpendicular to the arrangement direction of the fan and the frequency converter, respectively.

In some embodiments of the present disclosure, the air outlet includes a first air outlet, a second air outlet, a third air outlet, and a fourth air outlet. The cooking air duct and the heat dissipation inlet that are located at one of the two sides of the frequency converter are in communication with the first air outlet. A communication air duct is further defined between the air guide part and the fan casing. The communication air duct is in communication with the second air outlet, the third air outlet, and the heat dissipation inlet located at the other of the two sides of the frequency converter. The fourth air outlet is in communication with the cooking air duct located at the other of the two sides of the frequency converter.

In some embodiments of the present disclosure, the first air outlet, the second air outlet, and the third air outlet are located at a side of the fan casing facing the air guide part and arranged sequentially in the direction perpendicular to the arrangement direction of the fan and the frequency converter. The fourth air outlet is formed at a side of the fan casing facing the cooking cavity.

In some embodiments of the present disclosure, the air guide part further defines a blowing air duct. An end of the blowing air duct is in communication with the air outlet, and the blowing air duct has a fifth air outlet located at a side of the blowing air duct in a direction perpendicular to an arrangement direction of the frequency converter and the magnetron.

In some embodiments of the present disclosure, the microwave oven further includes an air guide hood and an air guide cover plate. The air guide cover plate is connected to the air guide hood. The air guide cover plate and the air guide hood jointly define the heat dissipation air duct. The air guide cover plate is located at a side of the air guide hood facing away from the cooking cavity, the heat dissipation inlet is formed on the air guide hood, and the air guide hood and the air guide cover plate jointly define the heat dissipation outlet.

In some embodiments of the present disclosure, a plurality of frequency converters are provided, and the heat dissipation air duct is internally provided with a partition. The partition is disposed between every two adjacent frequency converters of the plurality of frequency converters.

In some embodiments of the present disclosure, the mounting cavity further includes a second mounting cavity located at a top side of the cooking cavity. The first mounting cavity is in communication with the second mounting cavity. A top of the cooking cavity has a microwave port. The microwave oven further includes a waveguide disposed in the second mounting cavity. The waveguide has an end configured to collect microwaves emitted by the magnetron and another end configured to emit the microwaves into the cooking cavity through the microwave port.

In some embodiments of the present disclosure, the microwave port is located at a center of the top of the cooking cavity, and the waveguide is inclined towards one of left and right sides of the housing that is close to the magnetron in a front-to-rear direction of the housing.

In some embodiments of the present disclosure, the mounting cavity further includes a third mounting cavity and a fourth mounting cavity. In the left-right direction of the housing, the third mounting cavity and the fourth mounting cavity are located at two sides of the cooking cavity, respectively. The third mounting cavity and the fan are located at one side of the housing. The third mounting cavity is in communication with the first mounting cavity. The housing has an air inlet formed at a side wall of the housing in which the third mounting cavity is located. The air inlet is in communication with the third mounting cavity.

In some embodiments of the present disclosure, an air inlet side of the fan faces a rear side of the housing, and the housing has an air inlet formed at a rear side wall of the housing. The air inlet is in communication with the first mounting cavity.

In some embodiments of the present disclosure, the housing includes an inner shell and an outer shell. The outer shell is disposed outside the inner shell. The cooking cavity is defined at an inner side of the inner shell. The mounting cavity is defined between the outer shell and the inner shell.

Additional aspects and advantages of the present disclosure will be provided in part in the following description, or will become apparent in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings, in which:

FIG. 1 is a rear view of a microwave oven without an outer shell and an air guide cover plate according to an embodiment of the present disclosure;

FIG. 2 is a perspective view of a microwave oven without an outer shell and an air guide cover plate according to an embodiment of the present disclosure;

FIG. 3 is a perspective view of a microwave oven without an outer shell according to an embodiment of the present disclosure;

FIG. 4 is a perspective view of a microwave oven without an upper outer shell, a left outer shell, and a right outer shell according to an embodiment of the present disclosure;

FIG. 5 is a perspective view of a fan of a microwave oven according to an embodiment of the present disclosure;

FIG. 6 is a perspective view of a fan and an air guide hood of a microwave oven according to an embodiment of the present disclosure;

FIG. 7 is a perspective view of a fan and an air guide hood of a microwave oven according to an embodiment of the present disclosure viewed from another perspective;

FIG. 8 is an exploded view of an air guide part of a microwave oven according to an embodiment of the present disclosure; and

FIG. 9 is a partial cross-sectional view of an air guide part of a microwave oven according to an embodiment of the present disclosure.

### REFERENCE NUMERALS

100, microwave oven;
1, housing; 11, outer shell; 111, heat dissipation hole; 12, mounting cavity; 121, first mounting cavity; 122, second mounting cavity; 123, third mounting cavity; 124, fourth mounting cavity;
2, fan; 21, fan casing; 22, air inlet; 23, air outlet; 231, first air outlet; 232, second air outlet; 233, third air outlet; 234, fourth air outlet;
3, frequency converter; 31, first frequency converter; 32, second frequency converter;
4, magnetron; 41, first magnetron; 42, second magnetron;
5, air guide part; 51, air guide hood; 52, air guide cover plate; 53, heat dissipation air duct; 531, heat dissipation inlet; 532, heat dissipation outlet; 533, first groove; 54, cooking air duct; 541, second groove; 542, third groove; 55, blowing air duct; 551, fifth air outlet;
6, waveguide.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

In the description of the present disclosure, it should be understood that, the orientation or the position indicated by terms such as “center”, “longitudinal”, “lateral”, “length”, “width”, “thickness”, “over”, “below”, “front”, “back”, “left”, “right”, “vertical”, “horizontal”, “top”, “bottom”, “in”, “out”, “clockwise”, “anti-clockwise”, “axial”, “radial” and “circumferential” should be construed to refer to the orientation and the position as shown in the drawings, and is only for the convenience of describing the present disclosure and simplifying the description, rather than indicating or implying that the pointed device or element must have a specific orientation, or be constructed and operated in a specific orientation, and therefore cannot be understood as a limitation of the present disclosure. In addition, the features associated with “first” and “second” may explicitly or implicitly include at least one of the features or more of the features. In the description of the present disclosure, unless otherwise specified, “plurality” means at least two.

In the description of the present disclosure, it should be noted that, unless otherwise clearly specified and limited, terms such as “install”, “connect”, “couple”, and the like should be understood in a broad sense. For example, it may be a fixed connection or a detachable connection or a connection as one piece; a mechanical connection or an electrical connection; a direct connection or an indirect connection through an intermediate; or internal communication of two components. For those of ordinary skill in the art, the specific meaning of the above terms in the present disclosure should be understood according to specific circumstances.

A microwave oven 100 according to the embodiments of the present disclosure is described below with reference to the accompanying drawings.

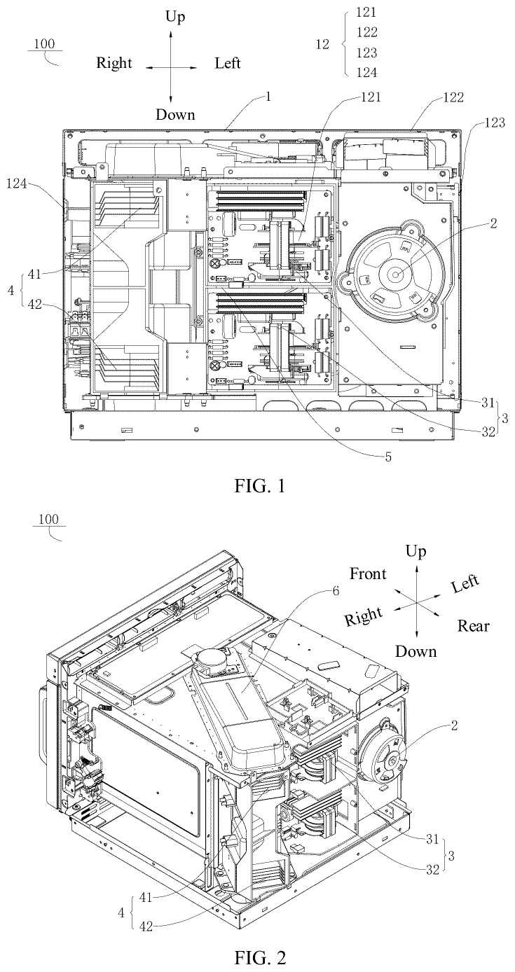

In an exemplary embodiment of the present disclosure, as shown in FIG. 1, the microwave oven 100 according to the embodiments of the present disclosure includes a housing 1, a fan 2, a frequency converter 3, and a magnetron 4.

The housing 1 has a cooking cavity inside the housing 1, and the housing 1 further has a mounting cavity 12 formed on the housing 1. An electrical component of the microwave oven 100 may be mounted in the mounting cavity 12. The mounting cavity 12 includes a first mounting cavity 121 located at a rear side of the cooking cavity. The fan 2, the frequency converter 3, and the magnetron 4 are disposed in the first mounting cavity 121. Therefore, the layout of the fan 2, the frequency converter 3, and the magnetron 4 in the microwave oven 100 is facilitated, making an overall structural layout of the microwave oven 100 reasonable and compact. During operation of the microwave oven 100, the frequency converter 3 itself generates some heat, and the frequency converter 3 is relatively sensitive to an ambient temperature and needs to maintain at a low temperature. The magnetron 4 generates the greatest amount of heat during its operation and has relatively higher temperature tolerance than other components in the microwave oven 100.

In a left-right direction of the housing 1, the fan 2 and the magnetron 4 are located at two sides of the frequency converter 3, respectively. At this time, cooling air blown by the fan 2 flows over the frequency converter 3 to effectively dissipate heat from the frequency converter 3, improving performance of the frequency converter 3 and maintaining stability of the frequency converter 3. After the cooling air flows over the frequency converter 3 and takes away the heat from the frequency converter 3, the cooling air is blown to the magnetron 4 to dissipate heat from the magnetron 4. According to different amounts of heat generated by the magnetron 4 and the frequency converter 3 during operation and different requirements of the magnetron 4 and the frequency converter 3 for a surrounding temperature, the cooling air blown by the fan 2 is allowed to provide an optimal heat dissipation effect for the magnetron 4 and the frequency converter 3, improving overall performance and a service life of the microwave oven 100.

With the microwave oven 100 according to the embodiments of the present disclosure, the fan 2, the frequency converter 3, and the magnetron 4 are disposed in the first mounting cavity 121 at the rear side of the cooking cavity, and the fan 2 and the magnetron 4 are respectively located at the two sides of the frequency converter 3 in the left-right direction of the housing 1. Therefore, the cooling air blown by the fan 2 flows over the frequency converter 3 to effectively dissipate heat from the frequency converter 3. After taking away the heat from the frequency converter 3, the cooling air is blown to the magnetron 4 to dissipate heat from the magnetron 4. According to the different amounts of heat generated by the magnetron 4 and the frequency converter 3 during the operation and the different requirements of the magnetron 4 and the frequency converter 3 for the surrounding temperature, the cooling air blown by the fan 2 is allowed to provide the optimal heat dissipation effect for the magnetron 4 and the frequency converter 3, improving the overall performance and the service life of the microwave oven 100.

In some embodiments of the present disclosure, a plurality of frequency converters 3 and a plurality of magnetrons 4 are provided. The plurality of magnetrons 4 correspond to the plurality of frequency converters 3 in a one-to-one correspondence. When the microwave oven 100 is in operation, different numbers of frequency converters 3 and magnetrons 4 may be activated to adjust a heating temperature and achieve different cooking effects. In addition, the one-to-one correspondence between the magnetrons 4 and the frequency converters 3 allows a voltage of each magnetron 4 to be regulated by a corresponding frequency converter 3. In this way, the magnetrons 4 can operate quickly, improving operation efficiency of the microwave oven 100.

For example, in examples shown in FIG. 1 and FIG. 2, there are two frequency converters 3 and two magnetrons 4, and the two magnetrons 4 correspond to the two frequency converters 3 in a one-to-one correspondence, realizing a dual-microwave generation system of the microwave oven 100.

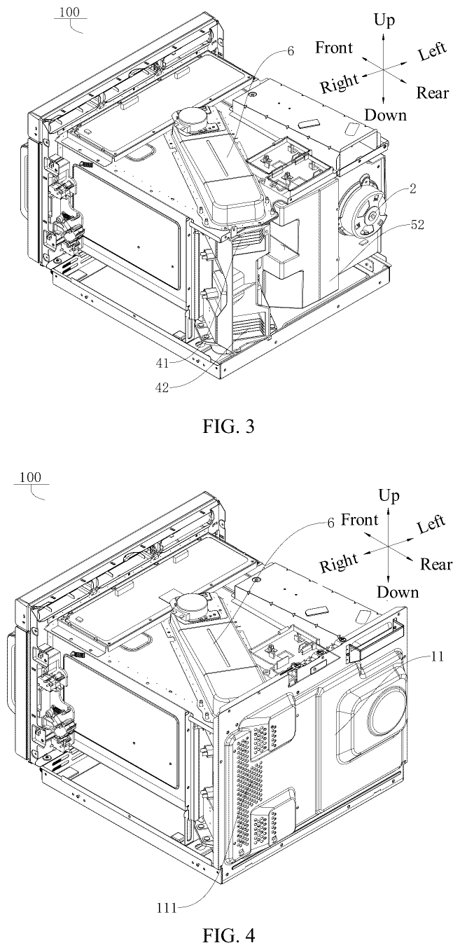

In some embodiments of the present disclosure, as shown in FIG. 1, FIG. 2, and FIG. 3, the plurality of frequency converters 3 are arranged in an up-down direction of the housing 1, and the plurality of magnetrons 4 are arranged in the up-down direction of the housing 1. At this time, the frequency converters 3 and the magnetrons 4 are positioned in a relatively concentrated arrangement, which can save a space of the first mounting cavity 121 in the left-right direction. Moreover, the positions of the frequency converters 3 correspond to the positions of the magnetrons 4 in a one-to-one correspondence in the left-right direction, facilitating connections between the frequency converters 3 and the magnetrons 4.

In some embodiments of the present disclosure, as shown in FIG. 1, FIG. 2, and FIG. 3, the plurality of frequency converters 3 includes a first frequency converter 31 and a second frequency converter 32, and the plurality of magnetrons 4 includes a first magnetron 41 and a second magnetron 42. The first frequency converter 31 is connected to the first magnetron 41, and the second frequency converter 32 is connected to the second magnetron 42. At this time, the first frequency converter 31, the second frequency converter 32, the first magnetron 41, and the second magnetron 42 are mounted in the first mounting cavity 121. The first frequency converter 31 and the second frequency converter 32 are arranged in the up-down direction, and the first magnetron 41 and the second magnetron 42 are arranged in the up-down direction. As shown in FIG. 1, the first magnetron 41 is located at a right side of the first frequency converter 31, the second magnetron 42 is located at a right side of the second frequency converter 32, and the fan 2 is located at left sides of the first magnetron 41 and the second magnetron 42.

In this way, a volume utilization rate of the first mounting cavity 121 can be improved, and different heating modes of the microwave oven 100 can be realized. Meanwhile, the first frequency converter 31 is connected to the first magnetron 41, and the second frequency converter 32 is connected to the second magnetron 42. In this way, a voltage of the first magnetron 41 is regulated by the first frequency converter 31, a voltage of the second magnetron 42 is regulated by the second frequency converter 32, and the first magnetron 41 and the second magnetron 42 can operate quickly, improving the operation efficiency of the microwave oven 100.

In other embodiments of the present disclosure, the positions of the magnetron 4 and the fan 2 are interchangeable. One of the magnetron 4 and the fan 2 is located at a left side of the frequency converter 3, and the other of the magnetron 4 and the fan 2 is located at a right side of the frequency converter 3.

In some embodiments of the present disclosure, as shown in FIG. 1 and FIG. 4, the mounting cavity 12 further includes a second mounting cavity 122 located at a top side of the cooking cavity, and the first mounting cavity 121 is in communication with the second mounting cavity 122. A top of the cooking cavity has a microwave port. The microwave oven 100 further includes a waveguide 6 disposed in the second mounting cavity 122. The waveguide 6 has an end configured to collect microwaves emitted by the magnetron 4 and another end configured to emit the microwaves into the cooking cavity through the microwave port. The waveguide 6 may collect the microwaves emitted by the magnetron 4 at a connection between the first mounting cavity 121 and the second mounting cavity 122, and guide the collected microwaves to the microwave port at the top of the cooking cavity, to allow the microwaves to enter the cooking cavity through the microwave port. In this way, a utilization rate of the microwaves generated by the magnetron 4 is improved, improving the operation efficiency of the microwave oven 100.

In some embodiments of the present disclosure, as shown in FIG. 3 and FIG. 4, the microwave port is located at a center of the top of the cooking cavity, and the waveguide 6 is inclined, in a front-to-rear direction of the housing 1, towards one of left and right sides of the housing 1 that is close to the magnetron 4. The microwave port located at the center of the top of the cooking cavity may make the microwaves entering the cooking cavity more uniform, and thus the microwave oven 100 heats food more evenly. The inclined waveguide 6 may also save a mounting space of the waveguide 6 in the second mounting cavity 122, which allows for a sufficient mounting space for other electrical components in the second mounting cavity 122, and reduces an increase in a volume of the second mounting cavity 122 caused by stacked placement of the electrical components. In this way, it is possible to reduce a volume of the microwave oven 100. The microwave oven 100 occupies a relatively small space during logistics transportation, which can improve a load carrying capacity during transportation of the microwave oven 100 and save logistics costs.

In some embodiments of the present disclosure, as shown in FIG. 1, the mounting cavity 12 further includes a third mounting cavity 123 and a fourth mounting cavity 124. In the left-right direction of the housing 1, the third mounting cavity 123 and the fourth mounting cavity 124 are located at two sides of the cooking cavity, respectively. The third mounting cavity 123 and the fan 2 are located at one side of the housing 1. The third mounting cavity 123 is in communication with the first mounting cavity 121. The housing 1 has an air inlet 22 formed at a side wall of the housing 1 in which the third mounting cavity 123 is located. The air inlet 22 is in communication with the third mounting cavity 123. At this time, an air inlet side of the fan 2 faces a front side. By forming the third mounting cavity 123 and the fourth mounting cavity 124 at two sides of the housing 1, the cooking cavity may be thermally insulated, improving heating efficiency of the microwave oven 100. Meanwhile, the third mounting cavity 123 and the fourth mounting cavity 124 may also provide sound insulation for a heating process in the cooking cavity, making noise generated during the operation of the microwave oven 100 relatively low. Moreover, the fan 2 may draw air from the air inlet 22 in communication with the third mounting cavity 123, and external cooling air enters the third mounting cavity 123 through the air inlet 22, enters the first mounting cavity 121 where the fan 2 is located under the suction of the fan 2, then enters the fan 2. The fan 2 delivers the external cooling air to the frequency converter 3 and the magnetron 4 to realize heat dissipation for the frequency converter 3 and the magnetron 4.

In other embodiments of the present disclosure, the present disclosure is not limited to this. The air inlet side of the fan 2 faces a rear side of the housing 1, and the housing 1 has an air inlet 22 formed at a rear side wall of the housing 1. The air inlet 22 is in communication with the first mounting cavity 121. At this time, the fan 2 may draw air from the air inlet 22 at the rear side wall of the housing 1, and the external cooling air enters the first mounting cavity 121 through the air inlet 22, enters the fan 2 under the suction of the fan 2. The fan 2 delivers the external cooling air to the frequency converter 3 and the magnetron 4 to realize the heat dissipation for the frequency converter 3 and the magnetron 4.

In some embodiments of the present disclosure, the housing 1 includes an inner shell and an outer shell 11. The outer shell 11 is disposed outside the inner shell, the cooking cavity 12 is defined at an inner side of the inner shell, and the mounting cavity 12 is defined between the outer shell 11 and the inner shell. The inner shell makes a structure of the cooking cavity more stable. The electrical components of the microwave oven 100 may be mounted in the mounting cavity 12 defined between the outer shell 11 and the inner shell. The outer shell 11 may protect the electrical components from being damaged by an external environment. The inner shell may isolate the electrical components from the cooking cavity, preventing water vapor in the cooking cavity from flowing onto the electrical components and causing short circuits of the electrical components.

As shown in FIG. 4, the outer shell 11 further has a heat dissipation hole 111 formed at the rear side of the outer shell 11, and the heat dissipation hole 111 is opposite to the magnetron 4. An airflow, after sequentially dissipates heat from the frequency converter 3 and the magnetron 4, may be discharged through the heat dissipation hole 111, realizing circulation of the airflow with external air and thus better achieving the heat dissipation of the microwave oven 100.

In some embodiments of the present disclosure, as shown in FIG. 3, the microwave oven 100 further includes an air guide part 5. The air guide part 5 is disposed in the first mounting cavity 121 and located between the fan 2 and the magnetron 4. The air guide part 5 has a heat dissipation air duct 53 defined in the air guide part 5. The frequency converter 3 is located in the heat dissipation air duct 53. The heat dissipation air duct 53 is configured to guide air blown by the fan 2 to the frequency converter 3 and the magnetron 4. By providing the air guide part 5, the air blown by the fan 2 may be concentrated in the heat dissipation air duct 53, which can improve use efficiency of the cooling air blown by the fan 2 and enhance heat dissipation efficiency of the microwave oven 100.

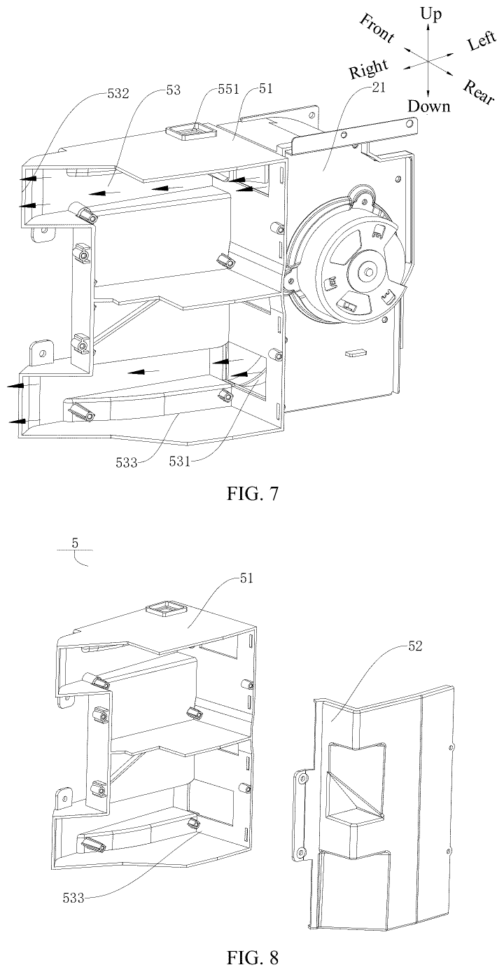

In some embodiments of the present disclosure, as shown in FIG. 7, the heat dissipation air duct 53 has a heat dissipation inlet 531 facing the fan 2 and a heat dissipation outlet 532 facing the magnetron 4. An airflow blown from the fan 2 enters the heat dissipation air duct 53 through the heat dissipation inlet 531, flows through the frequency converter 3 along the heat dissipation air duct 53, takes away the heat from the frequency converter 3, and then is blown to the magnetron 4 through the heat dissipation outlet 532 to realize the heat dissipation for the magnetron 4.

Further, as shown in FIG. 7, the heat dissipation air duct 53 has a first groove 533 formed on a wall surface of the heat dissipation air duct 53 close to the cooking cavity. The first groove 533 extends in an arrangement direction of the fan 2 and the frequency converter 3 and is located at a side of the frequency converter 3. The heat dissipation inlet 531 and the heat dissipation outlet 532 are in communication with the first groove 533. At this time, the airflow enters the first groove 533 through the heat dissipation inlet 531, takes away the heat from the frequency converter 3, and then is blown to the magnetron 4 through the heat dissipation outlet 532 to realize the heat dissipation for the magnetron 4. The arrangement of the first groove 533 may allow for a large cross-sectional area of the heat dissipation air duct 53 in a direction perpendicular to the arrangement direction of the fan 2 and the frequency converter 3, and allow more airflow to be blown to the frequency converter 3 and the first groove 533 to be machined conveniently. Meanwhile, a side wall of a side of the first groove 533 facing the frequency converter 3 has a relatively low height, which facilitates flow of cold air in the first groove 533 to the frequency converter 3, making a heat dissipation effect of the frequency converter 3 better, satisfying a temperature requirement of the frequency converter 3 for an operation environment. The frequency converter 3 generates less heat. After the cold air exchanges heat with the frequency converter 3, the cold air continues to flow in the heat dissipation air duct 53, flows out through the heat dissipation outlet 532, and flows towards the magnetron 4, which can dissipate a certain amount of heat from a magnetron 4 with a relatively great heat generation amount.

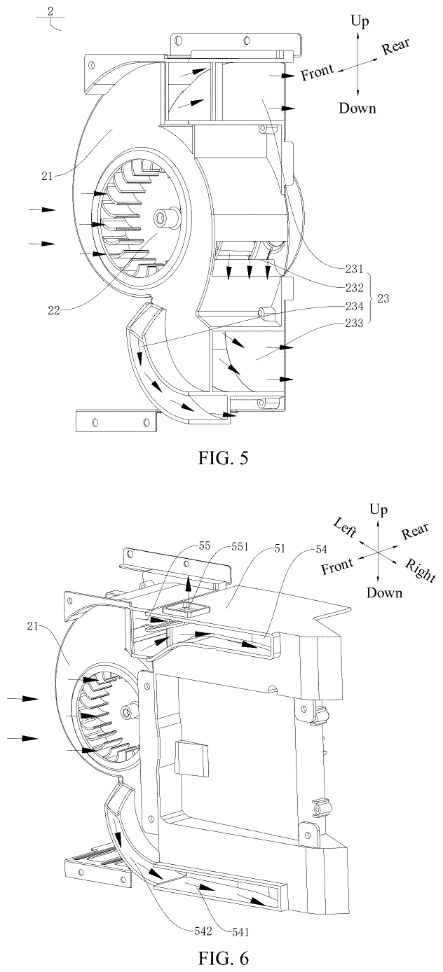

In some embodiments of the present disclosure, as shown in FIG. 2 and FIG. 5, the microwave oven 100 further includes a fan casing 21 disposed in the mounting cavity 12 and connected to the air guide part 5. The fan casing 21 has a fan cavity, and an air inlet 22 and an air outlet 23 that are in communication with the fan cavity. The fan 2 is disposed in the fan cavity to drive an airflow to flow from the air inlet 22 to the air outlet 23, and the heat dissipation inlet 531 is in communication with the air outlet 23. At this time, an airflow entering the fan 2 is relatively concentrated and flows towards the air outlet 23 under the guiding of the fan cavity, and more airflow is blown out from the air outlet 23. Therefore, more airflow is blown to the heat dissipation air duct 53, which can better perform the heat dissipation on the frequency converter 3 and the magnetron 4, achieving a better heat dissipation effect.

In some embodiments of the present disclosure, as shown in FIG. 6, the air guide part 5 further defines a cooking air duct 54 in communication with the air outlet 23, and the cooking air duct 54 is in communication with the cooking cavity. An airflow entering the cooking air duct 54 may dissipate heat from the cooking cavity, reducing a risk of damage to the microwave oven 100 caused by overheating of the cooking cavity.

In some embodiments of the present disclosure, as shown in FIG. 6, the cooking air duct 54 includes a second groove 541 formed at a side of the air guide part 5 facing the cooking cavity. An end of the second groove 541 is in communication with the air outlet 23, and an opening of the second groove 541 is in communication with the cooking cavity. At this time, the airflow flows from the air outlet 23 of the fan casing 21 into the second groove 541, and then flows from the opening of the second groove 541 to the cooking cavity, which can dissipate heat from the cooking cavity and reduce the risk of the damage to the microwave oven 100 caused by the overheating of the cooking cavity. By forming the second groove 541, an airflow entering the second groove 541 may flow along the second groove 541, while the air is blown outwards from the opening of the second groove 541, making the airflow blown out from the second groove 541 evenly distributed in the left-right direction. Moreover, the second groove 541 may reduce machining difficulty of the air guide part 5.

In some embodiments of the present disclosure, as shown in FIG. 6, the fan casing 21 has a third groove 542 formed at a side of the fan casing 21 facing the cooking cavity. The third groove 542 has an end in communication with the air outlet 23 and another end in communication with the second groove 541. The second groove 541 is in communication with the air outlet 23 through the third groove 542. An opening of the third groove 542 is in communication with the cooking cavity. At this time, the airflow flows from the air outlet 23 of the fan casing 21 to the third groove 542. A part of the airflow flows to the cooking cavity through the opening of the third groove 542, and the other part of the airflow flows to the second groove 541 and then to the cooking cavity through the second groove 541 to dissipate heat from the cooking cavity, reducing the risk of the damage to the microwave oven 100 caused by the overheating of the cooking cavity. Moreover, the third groove 542 may reduce machining difficulty of the fan casing 21.

In some embodiments of the present disclosure, as shown in FIG. 6, two cooking air ducts 54 are provided and are located at two sides of the frequency converter 3 in a direction perpendicular to an arrangement direction of the fan 2 and the frequency converter 3, respectively. Two heat dissipation inlets 531 are provided and are located at the two sides of the frequency converter 3 in the direction perpendicular to the arrangement direction of the fan 2 and the frequency converter 3, respectively. Correspondingly, two first grooves 533 and two heat dissipation outlets 532 are formed, and the frequency converter 3 is located between the two first grooves 533. At this time, the cooking air duct 54 may blow the cooling air to the cooking cavity from the two sides in the direction perpendicular to the arrangement direction of the fan 2 and the frequency converter 3, and may dissipate heat from the cooking cavity in both up and down directions, which can achieve a better heat dissipation effect. The heat dissipation air duct 53 may draw air from the two heat dissipation inlets 531 located at the two sides in the direction perpendicular to the arrangement direction of the fan 2 and the frequency converter 3 and sequentially dissipate heat from the frequency converter 3 and the magnetron 4 in both the up and down directions, which allows for the more uniform heat dissipation for the frequency converter 3 and the magnetron 4.

In some embodiments of the present disclosure, as shown in FIG. 5, the air outlet 23 includes a first air outlet 231, a second air outlet 232, a third air outlet 233, and a fourth air outlet 234. The cooking air duct 54 and the heat dissipation inlet 531 that are located at one of the two sides (an upper side as shown in FIG. 5) of the frequency converter 3 are in communication with the first air outlet 231. A communication air duct is further defined between the air guide part 5 and the fan casing 21. The communication air duct is in communication with the second air outlet 232, the third air outlet 233, and the heat dissipation inlet 531 located at the other of the two sides (a lower side as shown in FIG. 5) of the frequency converter 3. The fourth air outlet 234 is in communication with the cooking air duct 54 located at the other of the two sides (the lower side as shown in FIG. 5) of the frequency converter 3. At this time, the first air outlet 231 has a relatively large size and may be in communication with the cooking air duct 54 and the heat dissipation inlet 531 that are located at the one of the two sides of the frequency converter 3, which realizes air inflow for the cooking air duct 54 and the heat dissipation air duct 53 that are located at the one of the two sides of the frequency converter 3 and realizes the heat dissipation for the cooking cavity, the frequency converter 3, and the magnetron 4. The air blown out from the second air outlet 232 and the third air outlet 233 is concentrated into the communication air duct and jointly blown towards the heat dissipation inlet 531 at the other of the two sides of the frequency converter 3, thus flowing into the heat dissipation air duct 53 at the other of the two sides of the frequency converter 3 to realize the heat dissipation for the frequency converter 3 and the magnetron 4. The air blown out from the fourth air outlet 234 enters the third groove 542 located on the fan casing 21, and is blown along the third groove 542 towards the second groove 541 located on the air guide part 5 while being blown towards the cooking cavity, and is blown from the second groove 541 to the cooking cavity, realizing the heat dissipation for the cooking cavity.

In some embodiments of the present disclosure, as shown in FIG. 5, the first air outlet 231, the second air outlet 232, and the third air outlet 233 are located at a side of the fan casing 21 facing the air guide part 5 and arranged sequentially in the direction perpendicular to the arrangement direction of the fan 2 and the frequency converter 3. The fourth air outlet 234 is formed at a side of the fan casing facing the cooking cavity. At this time, the first air outlet 231 has a relatively large size, is located above the fan casing 21, and may be in communication with the cooking air duct 54 and the heat dissipation inlet 531 that are located at the upper side, which realizes air inflow of the cooking air duct 54 and the heat dissipation air duct 53 that are located at the upper side, and realizes the heat dissipation for the cooking cavity and upper ends of the frequency converter 3 and the magnetron 4. The air blown out from the second air outlet 232 and the third air outlet 233 is concentrated into the communication air duct and jointly blown towards the heat dissipation inlet 531 located at the lower side, thus flowing into the heat dissipation air duct 53 located at the lower side to realize the heat dissipation for lower ends of the frequency converter 3 and the magnetron 4. The fourth air outlet 234 faces the cooking cavity. Therefore, the blown air enters the third groove 542 located on the fan casing 21, and is blown along the third groove 542 towards the second groove 541 located on the air guide part 5 while being blown towards the cooking cavity, and is blown from the second groove 541 to the cooking cavity, realizing the heat dissipation for the cooking cavity.

In some embodiments of the present disclosure, as shown in FIG. 5, the air guide part 5 further defines a blowing air duct 55. An end of the blowing air duct 55 is in communication with the air outlet 23 (such as the first air outlet 231). The blowing air duct 55 has a fifth air outlet 551 located at a side (a lower side as shown in FIG. 5) of the blowing air duct 55 in a direction perpendicular to an arrangement direction of the frequency converter 3 and the magnetron 4. At this time, the airflow is blown out from the fifth air outlet 551 and flows to an upper part of the air guide part 5 to dissipate the heat from an electrical component mounted there, realizing stable operation of other electrical components.

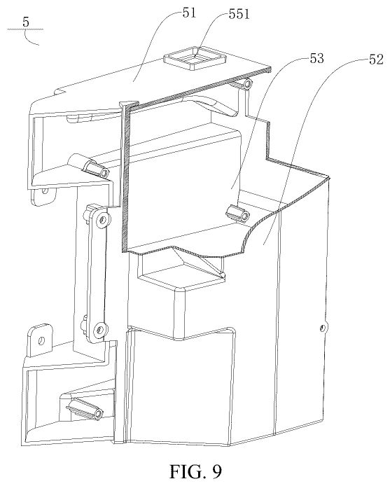

In some embodiments of the present disclosure, as shown in FIG. 8 and FIG. 9, the air guide part 5 includes an air guide hood 51 and an air guide cover plate 52. The air guide cover plate 52 is connected to the air guide hood 51. The air guide cover plate 52 and the air guide hood 51 jointly define the heat dissipation air duct 53. The air guide cover plate 52 is located at a side of the air guide hood 51 facing away from the cooking cavity. The heat dissipation inlet 531 is formed on the air guide hood 51. The air guide hood 51 and the air guide cover plate 52 jointly define the heat dissipation outlet 532. At this time, the air guide cover plate 52 may cover the frequency converter 3, which allows the frequency converter 3 to be located in the heat dissipation air duct 53 to achieve a better heat dissipation effect. Moreover, the air guide cover plate 52 is detachable from the air guide hood 51 and may be removed during maintenance of the frequency converter 3, making the frequency converter 3 be in a detectable state. The air guide cover plate 52 may also protect the frequency converter 3, reducing a risk of external damage to the frequency converter 3 to some extent.

In some embodiments of the present disclosure, a plurality of frequency converters 3 are provided, and the heat dissipation air duct 53 is internally provided with a partition. The partition is disposed between every two adjacent frequency converters 3 of the plurality of frequency converters 3, which can make two frequency converters 3 spaced apart from each other, and avoid mutual interference of the frequency converters 3 during the operation of the frequency converters 3. Meanwhile, when one frequency converter 3 fails, it is possible to reduce a risk that the other frequency converter 3 is affected and fails.

A microwave oven 100 according to a specific embodiment of the present disclosure is described below with reference to the accompanying drawings. It should be understood that the following description is only exemplary and is intended to explain the present disclosure, and shall not be construed as limiting the present disclosure.

In an exemplary embodiment of the present disclosure, as shown in FIG. 1, the microwave oven 100 includes a housing 1, a fan 2, a frequency converter 3, a magnetron 4, an air guide part 5, and a waveguide 6.

The housing 1 has a cooking cavity inside the housing 1, and the housing 1 further has a mounting cavity 12 formed on the housing 1. An electrical component of the microwave oven 100 may be mounted in the mounting cavity 12. The fan 2, the frequency converter 3, and the magnetron 4 are disposed in the mounting cavity 12. Therefore, the layout of the fan 2, the frequency converter 3, and the magnetron 4 in the microwave oven 100 is facilitated, making an overall structural layout of the microwave oven 100 reasonable and compact. During operation of the microwave oven 100, the frequency converter 3 itself generates some heat, and the frequency converter 3 is relatively sensitive to an ambient temperature and needs to maintain at a low temperature. The magnetron 4 generates the greatest amount of heat during its operation and has relatively higher temperature tolerance than other components in the microwave oven 100.

There are two frequency converters 3 and two magnetrons 4, and the two magnetrons 4 correspond to the two frequency converters 3 in a one-to-one correspondence, realizing a dual-microwave generation system of the microwave oven 100. A first frequency converter 31 is connected to a first magnetron 41, and a second frequency converter 32 is connected to a second magnetron 42. The first frequency converter 31 and the second frequency converter 32 are arranged in an up-down direction, and the first magnetron 41 and the second magnetron 42 are arranged in the up-down direction. As shown in FIG. 1, the first magnetron 41 is located at a right side of the first frequency converter 31, the second magnetron 42 is located at a right side of the second frequency converter 32, and the fan 2 is located at left sides of the first magnetron 41 and the second magnetron 42. The fan 2 and the magnetron 4 are located at two opposite sides of the frequency converter 3, respectively. At this time, an airflow blown by the fan 2 flows over the frequency converter 3 to effectively dissipate heat from the frequency converter 3, and then is blown to the magnetron 4 to dissipate heat from the magnetron 4.

As shown in FIG. 6 and FIG. 7, the air guide part 5 is disposed in the mounting cavity 12 and located between the fan 2 and the magnetron 4. The air guide part 5 has a heat dissipation air duct 53 defined in the air guide part 5. The frequency converter 3 is located in the heat dissipation air duct 5. The heat dissipation air duct 53 has a heat dissipation inlet 531 facing the fan 2 and a heat dissipation outlet 532 facing the magnetron 4. The airflow blown from the fan 2 enters the heat dissipation air duct 53 through the heat dissipation inlet 531, flows through the frequency converter 3 along the heat dissipation air duct 53, takes away the heat from the frequency converter 3, and then is blown to the magnetron 4 through the heat dissipation outlet 532 to realize the heat dissipation for the magnetron 4.

The heat dissipation air duct 53 has a first groove 533 formed on a wall surface of the heat dissipation air duct 53 close to the cooking cavity. The first groove 533 extends in an arrangement direction of the fan 2 and the frequency converter 3 and is located at a side of the frequency converter 3, and the heat dissipation inlet 531 and the heat dissipation outlet 532 are in communication with the first groove 533. At this time, the airflow enters the first groove 533 through the heat dissipation inlet 531, takes away the heat from the frequency converter 3, and then is blown to the magnetron 4 through the heat dissipation outlet 532 to realize the heat dissipation for the magnetron 4. The arrangement of the first groove 533 may allow for a large cross-sectional area of the heat dissipation air duct 53 in a direction perpendicular to the arrangement direction of the fan 2 and the frequency converter 3, and allow more airflow to be blown to the frequency converter 3 and the first groove 533 to be machined conveniently. Meanwhile, a side wall of a side of the first groove 533 facing the frequency converter 3 has a relatively low height, which facilitates flow of cold air in the first groove 533 to the frequency converter 3, making a heat dissipation effect of the frequency converter 3 better, satisfying a temperature requirement of the frequency converter 3 for an operation environment. The frequency converter 3 generates less heat. After the cold air exchanges heat with the frequency converter 3, the cold air continues to flow in the heat dissipation air duct 53, flows out through the heat dissipation outlet 532, and flows towards the magnetron 4, which can dissipate a certain amount of heat from a magnetron 4 with a relatively great heat generation amount.

As shown in FIG. 7, a plurality of frequency converters 3 are provided, and the heat dissipation air duct 53 is internally provided with a partition. The partition is disposed between every two adjacent frequency converters 3 of the plurality of frequency converters 3, which can make two frequency converters 3 spaced apart from each other, and avoid mutual interference of the frequency converters 3 during operation of the frequency converters 3. Meanwhile, when one frequency converter 3 fails, it is possible to reduce a risk that the other frequency converter 3 is affected and fails.

As shown in FIG. 6, the air guide part 5 further defines a cooking air duct 54 in communication with the air outlet 23, and the cooking air duct 54 is in communication with the cooking cavity. An airflow entering the cooking air duct 54 may dissipate heat from the cooking cavity, reducing a risk of damage to the microwave oven 100 caused by overheating of the cooking cavity. The cooking air duct 54 includes a second groove 541 formed at a side of the air guide part 5 facing the cooking cavity. An end of the second groove 541 is in communication with the air outlet 23, and an opening of the second groove 541 is in communication with the cooking cavity. The fan casing 21 has a third groove 542 formed at a side of the fan casing 21 facing the cooking cavity. The third groove 542 has an end in communication with the air outlet 23 and another end in communication with the second groove 541. An opening of the third groove 542 is in communication with the cooking cavity. At this time, the airflow flows from the air outlet 23 of the fan casing 21 into the second groove 541 and the third groove 542. A part of the airflow flows to the cooking cavity through the opening of the third groove 542, and the other part of the airflow flows to the second groove 541 and then to the cooking cavity through the second groove 541 to dissipate heat from the cooking cavity, reducing the risk of the damage to the microwave oven 100 caused by the overheating of the cooking cavity. Moreover, the third groove 542 may reduce machining difficulty of the fan casing 21.

As shown in FIG. 6, two cooking air ducts 54 are provided and are located at two sides of the frequency converter 3 in a direction perpendicular to an arrangement direction of the fan 2 and the frequency converter 3, respectively. Two heat dissipation inlets 531 are provided and are located at the two sides of the frequency converter 3 in the direction perpendicular to the arrangement direction of the fan 2 and the frequency converter 3, respectively. Correspondingly, two first grooves 533 and two heat dissipation outlets 532 are formed, and the frequency converter 3 is located between the two first grooves 533. At this time, the cooking air duct 54 may blow cooling air to the cooking cavity from the two sides in the direction perpendicular to the arrangement direction of the fan 2 and the frequency converter 3, and may dissipate heat from the cooking cavity in both up and down directions, which can achieve a better heat dissipation effect. The heat dissipation air duct 53 may draw air from the two heat dissipation inlets 531 located at the two sides in the direction perpendicular to the arrangement direction of the fan 2 and the frequency converter 3 and sequentially dissipate heat from the frequency converter 3 and the magnetron 4 in both the up and down directions, which allows for the more uniform heat dissipation for the frequency converter 3 and the magnetron 4.

As shown in FIG. 5, the air guide part 5 further defines a blowing air duct 55. An end of the blowing air duct 55 is in communication with a first air outlet 231. The blowing air duct 55 has a fifth air outlet 551 located at a lower side as shown in FIG. 5. At this time, the airflow is blown out from the fifth air outlet 551 and flows to an upper part of the air guide part 5 to dissipate the heat from an electrical component mounted there, realizing stable operation of other electrical components.

As shown in FIG. 8 and FIG. 9, the air guide part 5 includes an air guide hood 51 and an air guide cover plate 52. The air guide cover plate 52 is connected to the air guide hood 51. The air guide cover plate 52 and the air guide hood 51 jointly define the heat dissipation air duct 53. The air guide cover plate 52 is located at a side of the air guide hood 51 facing away from the cooking cavity. The heat dissipation inlet 531 is formed on the air guide hood 51. The air guide hood 51 and the air guide cover plate 52 jointly define the heat dissipation outlet 532. At this time, the air guide cover plate 52 may cover the frequency converter 3, which allows the frequency converter 3 to be located in the heat dissipation air duct 53 to achieve a better heat dissipation effect. Moreover, the air guide cover plate 52 is detachable from the air guide hood 51 and may be removed during maintenance of the frequency converter 3, making the frequency converter 3 be in a detectable state. The air guide cover plate 52 may also protect the frequency converter 3, reducing a risk of external damage to the frequency converter 3 to some extent.

As shown in FIG. 5, the fan casing 21 is disposed in the mounting cavity 12 and connected to the air guide part 5. The fan casing 21 has a fan cavity, and an air inlet 22 and an air outlet 23 that are in communication with the fan cavity. The fan 2 is disposed in the fan cavity to drive an airflow to flow from the air inlet 22 to the air outlet 23, and the heat dissipation inlet 531 is in communication with the air outlet 23. At this time, an airflow entering the fan 2 is relatively concentrated and flows towards the air outlet 23 under the guiding of the fan cavity, and more airflow is blown out from the air outlet 23. Therefore, more airflow is blown to the heat dissipation air duct 53, which can better perform the heat dissipation on the frequency converter 3 and the magnetron 4, achieving a better heat dissipation effect.

As shown in FIG. 5, the air outlet 23 includes a first air outlet 231, a second air outlet 232, a third air outlet 233, and a fourth air outlet 234. The cooking air duct 54 and the heat dissipation inlet 531 that are located at the upper side as shown in FIG. 5 are in communication with the first air outlet 231. A communication air duct is further defined between the air guide part 5 and the fan casing 21. The communication air duct is in communication with the second air outlet 232, the third air outlet 233, and the heat dissipation inlet 531 located at the lower side as shown in FIG. 5. The fourth air outlet 234 is in communication with the cooking air duct 54 located at the lower side as shown in FIG. 5. The first air outlet 231, the second air outlet 232, and the third air outlet 233 are located at a side of the fan casing 21 facing the air guide part 5 and arranged sequentially in the direction perpendicular to the arrangement direction of the fan 2 and the frequency converter 3, and the fourth air outlet 234 is formed at a side of the fan casing facing the cooking cavity. At this time, the first air outlet 231 has a relatively large size and may be in communication with the cooking air duct 54 and the heat dissipation inlet 531 that are located at one of the two sides of the frequency converter 3, which realizes air inflow for the cooking air duct 54 and the heat dissipation air duct 53 that are located at the one of the two sides of the frequency converter 3 and realizes heat dissipation for the cooking cavity, the frequency converter 3, and the magnetron 4. The air blown out from the second air outlet 232 and the third air outlet 233 is concentrated into the communication air duct and jointly blown towards the heat dissipation inlet 531 at the other of the two sides of the frequency converter 3, thus flowing into the heat dissipation air duct 53 at the other of the two sides of the frequency converter 3 to realize the heat dissipation for the frequency converter 3 and the magnetron 4 at the other of the two sides of the frequency converter 3. The air blown out from the fourth air outlet 234 enters the third groove 542 located on the fan casing 21, and is blown along the third groove 542 towards the second groove 541 located on the air guide part 5 while being blown towards the cooking cavity, and is blown from the second groove 541 to the cooking cavity, realizing the heat dissipation for the cooking cavity.

As shown in FIG. 1, the mounting cavity 12 has a first mounting cavity 121 located at a rear side of the cooking cavity. The fan 2, the frequency converter 3, the magnetron 4, and the air guide part 5 are each disposed in the first mounting cavity 121. Therefore, the layout of the fan 2, the frequency converter 3, and the magnetron 4 in the microwave oven 100 is facilitated, making an overall structural layout of the microwave oven 100 reasonable and compact. In the left-right direction of the housing 1, the fan 2 and the magnetron 4 are located at two sides of the frequency converter 3, respectively. At this time, the cooling air blown by the fan 2 flows over the frequency converter 3 to effectively dissipate heat from the frequency converter 3, improving performance of the frequency converter 3 and maintaining stability of the frequency converter 3. After the cooling air flows over the frequency converter 3 and takes away the heat from the frequency converter 3, the cooling air is blown to the magnetron 4 to dissipate heat from the magnetron 4. According to different amounts of heat generated by the magnetron 4 and the frequency converter 3 during operation and different requirements of the magnetron 4 and the frequency converter 3 for a surrounding temperature, the cooling air blown by the fan 2 is allowed to provide an optimal heat dissipation effect for the magnetron 4 and the frequency converter 3, improving overall performance and a service life of the microwave oven 100.

As shown in FIG. 1, the mounting cavity 12 further includes a second mounting cavity 122 located at a top side of the cooking cavity, and the first mounting cavity 121 is in communication with the second mounting cavity 122. A top of the cooking cavity has a microwave port. The microwave oven 100 further includes a waveguide 6 disposed in the second mounting cavity 122. The waveguide 6 has an end configured to collect microwaves emitted by the magnetron 4 and another end configured to emit the microwaves into the cooking cavity through the microwave port. The waveguide 6 may collect the microwaves emitted by the magnetron 4 at a connection between the first mounting cavity 121 and the second mounting cavity 122, and guide the collected microwaves to the microwave port at the top of the cooking cavity, to allow the microwaves to enter the cooking cavity through the microwave port. In this way, a utilization rate of the microwaves generated by the magnetron 4 is improved, improving operation efficiency of the microwave oven 100.

The microwave port is located at a center of the top of the cooking cavity, and the waveguide 6 is inclined, in a front-to-rear direction of the housing 1, towards one of left and right sides of the housing 1 that is close to the magnetron 4. The microwave port located at the center of the top of the cooking cavity may make the microwaves entering the cooking cavity more uniform, and thus the microwave oven 100 heats food more evenly. The inclined waveguide 6 may also save a mounting space of the waveguide 6 in the second mounting cavity 122, which allows for a sufficient mounting space for other electrical components in the second mounting cavity 122, and reduces an increase in a volume of the second mounting cavity 122 caused by stacked placement of the electrical components. In this way, it is possible to reduce a volume of the microwave oven 100. The microwave oven 100 occupies a relatively small space during logistics transportation, which can improve a load carrying capacity during transportation of the microwave oven 100 and save logistics costs.

As shown in FIG. 1, the mounting cavity 12 further includes a third mounting cavity 123 and a fourth mounting cavity 124. In the left-right direction of the housing 1, the third mounting cavity 123 and the fourth mounting cavity 124 are located at two sides of the cooking cavity, respectively. The third mounting cavity 123 and the fan 2 are located at one side of the housing 1. The third mounting cavity 123 is in communication with the first mounting cavity 121. The housing 1 has an air inlet 22 formed at a side wall of the housing 1 in which the third mounting cavity 123 is located. The air inlet 22 is in communication with the third mounting cavity 123. By forming the third mounting cavity 123 and the fourth mounting cavity 124 at two sides of the housing 1, the cooking cavity may be thermally insulated, improving heating efficiency of the microwave oven 100. Meanwhile, the third mounting cavity 123 and the fourth mounting cavity 124 may also provide sound insulation for a heating process in the cooking cavity, making noise generated during the operation of the microwave oven 100 relatively low.

As shown in FIG. 5, the air inlet side of the fan 2 faces a rear side of the housing 1, and the housing 1 has an air inlet 22 formed at a rear side wall of the housing 1. The air inlet 22 is in communication with the first mounting cavity 121. At this time, the fan 2 may draw air from the air inlet 22 at a rear side wall of the housing 1, and the external cooling air enters the first mounting cavity 121 through the air inlet 22, enters the fan 2 under the suction of the fan 2. The fan 2 delivers the external cooling air to the frequency converter 3 and the magnetron 4 to realize the heat dissipation for the frequency converter 3 and the magnetron 4.

The housing 1 includes an inner shell and an outer shell 11. The outer shell 11 is disposed outside the inner shell, the cooking cavity 12 is defined at an inner side of the inner shell, and the mounting cavity 12 is defined between the outer shell 11 and the inner shell. The inner shell makes a structure of the cooking cavity more stable. The electrical components of the microwave oven 100 may be mounted in the mounting cavity 12 defined between the outer shell 11 and the inner shell. The outer shell 11 may protect the electrical components from being damaged by an external environment. The inner shell may isolate the electrical components from the cooking cavity, preventing water vapor in the cooking cavity from flowing onto the electrical components and causing short circuits of the electrical components.

As shown in FIG. 4, the outer shell 11 further has a heat dissipation hole 111 formed at the rear side of the outer shell 11, and the heat dissipation hole 111 is opposite to the magnetron 4. The airflow, after sequentially dissipates heat from the frequency converter 3 and the magnetron 4, may be discharged through the heat dissipation hole 111, realizing circulation of the airflow with external air and thus achieving better heat dissipation for the microwave oven 100.

Other arrangements and operations of the microwave oven 100 according to the embodiments of the present disclosure are known to those of ordinary skill in the art, and the description thereof in detail will be omitted herein.

In the description of this specification, description with reference to “an embodiment”, “some embodiments”, “an illustrative embodiment”, “an example”, “a specific example”, “some examples”, or the like means that a particular feature, structure, material, or characteristic described in connection with the embodiment or example is included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner.

Although embodiments of the present disclosure have been illustrated and described, it is conceivable for those skilled in the art that various changes, modifications, replacements, and variations can be made to these embodiments without departing from the principles and spirit of the present disclosure. The scope of the present disclosure shall be defined by the claims as appended and their equivalents.

What is claimed is:

1. A microwave oven, comprising:
a housing having a cooking cavity inside the housing, wherein the housing further has a mounting cavity formed on the housing, the mounting cavity comprising a first mounting cavity located at a rear side of the cooking cavity;
a fan disposed in the first mounting cavity;
a frequency converter disposed in the first mounting cavity; and
a magnetron disposed in the first mounting cavity, wherein in a left-right direction of the housing, the fan and the magnetron are located at two sides of the frequency converter, respectively.

2. The microwave oven according to claim 1, wherein a plurality of frequency converters and a plurality of magnetrons are provided, the plurality of magnetrons corresponding to the plurality of frequency converters in a one-to-one correspondence.

3. The microwave oven according to claim 2, wherein:
the plurality of frequency converters are arranged in an up-down direction of the housing; and
the plurality of magnetrons are arranged in the up-down direction of the housing.

4. The microwave oven according to claim 2, wherein:
the plurality of frequency converters comprises a first frequency converter and a second frequency converter;
the plurality of magnetrons comprises a first magnetron and a second magnetron;
the first frequency converter is connected to the first magnetron; and
the second frequency converter is connected to the second magnetron.

5. The microwave oven according to any one of claims 1 to 4, further comprising an air guide part disposed in the first mounting cavity and located between the fan and the magnetron, wherein the air guide part has a heat dissipation air duct defined in the air guide part, the frequency converter being located in the heat dissipation air duct, the heat dissipation air duct having a heat dissipation inlet facing the fan and a heat dissipation outlet facing the magnetron, and the heat dissipation air duct being configured to guide air blown by the fan to the frequency converter and the magnetron.

6. The microwave oven according to claim 5, wherein the heat dissipation air duct has a first groove formed on a wall surface of the heat dissipation air duct close to the cooking cavity, wherein the first groove extends in an arrangement direction of the fan and the frequency converter and is located at a side of the frequency converter, and wherein the heat dissipation inlet and the heat dissipation outlet are in communication with the first groove.

7. The microwave oven according to claim 5, further comprising a fan casing disposed in the mounting cavity and connected to the air guide part, wherein the fan casing has a fan cavity, and an air inlet and an air outlet that are in communication with the fan cavity, the fan being disposed in the fan cavity to drive an airflow to flow from the air inlet to the air outlet, and the heat dissipation inlet being in communication with the air outlet.

8. The microwave oven according to claim 7, wherein the air guide part further defines a cooking air duct in communication with the air outlet, the cooking air duct being in communication with the cooking cavity.

9. The microwave oven according to claim 8, wherein the cooking air duct comprises a second groove formed at a side of the air guide part facing the cooking cavity, wherein an end of the second groove is in communication with the air outlet, and wherein an opening of the second groove is in communication with the cooking cavity.

10. The microwave oven according to claim 9, wherein the fan casing has a third groove formed at a side of the fan casing facing the cooking cavity, wherein the third groove has an end in communication with the air outlet and another end in communication with the second groove, and wherein an opening of the third groove is in communication with the cooking cavity.

11. The microwave oven according to claim 8, wherein:
two cooking air ducts are provided and are located at two sides of the frequency converter in a direction perpendicular to an arrangement direction of the fan and the frequency converter, respectively; and
two heat dissipation inlets are provided and are located at the two sides of the frequency converter in the direction perpendicular to the arrangement direction of the fan and the frequency converter, respectively.

12. The microwave oven according to claim 11, wherein the air outlet comprises a first air outlet, a second air outlet, a third air outlet, and a fourth air outlet, wherein:
the cooking air duct and the heat dissipation inlet that are located at one of the two sides of the frequency converter are in communication with the first air outlet;
a communication air duct is further defined between the air guide part and the fan casing;
the communication air duct is in communication with the second air outlet, the third air outlet, and the heat dissipation inlet located at the other of the two sides of the frequency converter; and
the fourth air outlet is in communication with the cooking air duct located at the other of the two sides of the frequency converter.

13. The microwave oven according to claim 12, wherein:
the first air outlet, the second air outlet, and the third air outlet are located at a side of the fan casing facing the air guide part and arranged sequentially in the direction perpendicular to the arrangement direction of the fan and the frequency converter; and
the fourth air outlet is formed at a side of the fan casing facing the cooking cavity.

14. The microwave oven according to claim 7, wherein the air guide part further defines a blowing air duct, wherein:
an end of the blowing air duct is in communication with the air outlet; and
the blowing air duct has a fifth air outlet located at a side of the blowing air duct in a direction perpendicular to an arrangement direction of the frequency converter and the magnetron.

15. The microwave oven according to claim 5, wherein the air guide part comprises:
an air guide hood; and
an air guide cover plate connected to the air guide hood, the air guide cover plate and the air guide hood jointly defining the heat dissipation air duct, wherein the air guide cover plate is located at a side of the air guide hood facing away from the cooking cavity, wherein the heat dissipation inlet is formed on the air guide hood, and wherein the air guide hood and the air guide cover plate jointly define the heat dissipation outlet.

16. The microwave oven according to claim 5, wherein a plurality of frequency converters are provided, and wherein the heat dissipation air duct is internally provided with a partition, the partition being disposed between every two adjacent frequency converters of the plurality of frequency converters.

17. The microwave oven according to any one of claims 1 to 16, wherein:
the mounting cavity further comprises a second mounting cavity located at a top side of the cooking cavity, the first mounting cavity being in communication with the second mounting cavity;
a top of the cooking cavity has a microwave port; and
the microwave oven further comprises a waveguide disposed in the second mounting cavity, the waveguide having an end configured to collect microwaves emitted by the magnetron and another end configured to emit the microwaves into the cooking cavity through the microwave port.

18. The microwave oven according to claim 17, wherein:
the microwave port is located at a center of the top of the cooking cavity; and
the waveguide is inclined, in a front-to-rear direction of the housing, towards one of left and right sides of the housing that is close to the magnetron.

19. The microwave oven according to any one of claims 1 to 18, wherein the mounting cavity further comprises a third mounting cavity and a fourth mounting cavity, wherein:
in the left-right direction of the housing, the third mounting cavity and the fourth mounting cavity are located at two sides of the cooking cavity, respectively;
the third mounting cavity and the fan are located at one side of the housing;
the third mounting cavity is in communication with the first mounting cavity; and
the housing has an air inlet formed at a side wall of the housing in which the third mounting cavity is located, the air inlet being in communication with the third mounting cavity.

20. The microwave oven according to any one of claims 1 to 19, wherein an air inlet side of the fan faces a rear side of the housing, and wherein the housing has an air inlet formed at a rear side wall of the housing, the air inlet being in communication with the first mounting cavity.

21. The microwave oven according to any one of claims 1 to 20, wherein the housing comprises an inner shell and an outer shell, wherein:
the outer shell is disposed outside the inner shell;
the cooking cavity is defined at an inner side of the inner shell; and
the mounting cavity is defined between the outer shell and the inner shell.
